(19) United States
(12) Patent Application Publication
(10) Pub. No.: US 2007/0082979 A1
(43) Pub. Date: Apr. 12, 2007

(54) Use of comb-structured bead-form polymers, and resulting compositions

(76) Inventors: Emmanuel Villard, St-Christo-en-Jarez (FR); Haraelo Naranjo, Chavanay (FR); Pierre Lyot, Saint-Etienne (FR)

Correspondence Address: GREENBLUM & BERNSTEIN, P.L.C., 1950 ROLAND CLARKE PLACE, RESTON, VA, 20191, US

(21) Appl. No.: 10/576,305

(22) PCT Filed: Oct. 18, 2004
(86) PCT No.: PCT/IB04/03392

§ 371 Date: Apr. 19, 2006

(30) Foreign Application Priority Data
Oct. 23, 2003 (FR) 03 12428

(51) Int. Cl. C04B 24/26

(52) U.S. Cl. 524/5

(57) ABSTRACT

The present invention relates to compositions including organic and/or inorganic fillers and at least one comb-structured bead-from polymer. The bead-form polymer has: an apparent specific gravity higher than 0.5 and preferably higher than 0.7, a spherical shape and physical properties such as greater flowability, a better particle size distribution whereby a high fine particle content is averted, and a lower specific surface area whereby the moisture regain rate is lowered and caking is reduced as a result of which an overall improvement in the use conditions is achieved when the polymer is used as a plasticizer, a superplasticizer or a dispersing agent, in comparison with the conditions observed during the use of the same materials marketed in solid form (e.g. as a fine powder prepared by spray drying), particularly by virtue of the very fast availability of the polymer in the medium. Use of comb-structured bead-form polymers as: plasticizers, superplasticizers, water reducers and high-reduction water reducers in compositions that include a hydraulic binder, e.g. concrete, mortar, slag, slurry and gypsum, and also as dispersing agents for organic and/or inorganic fillers, for example, but not exclusively, in compositions such as paints, coatings and detergent, softening or cosmetic compositions.

The present invention relates to the technical field of comb-structured polymers used as plasticizers, superplasticizers, water reducers, high-reduction water reducers in compositions that include a hydraulic binder, such as concrete, mortar, slag, slurry, gypsum, also used as dispersing agents for organic and/or inorganic fillers, for example, but not limited to, in compositions such as paints, coatings, and detergent, softening, or cosmetic compositions, etc.

A “comb” polymer is characterized by one with ordinary skill in the art when its structure, similar to that of a comb, includes a main chain to which are attached side chains that can be of a different type and variable length (hydrophilic and/or hydrophobic, of the ethylene oxide, propylene oxide, alkyl types, etc., with lengths from 2 to 500 units, and preferably from 5 to 200 units in the case of a pendant chain of the polyethylene oxide type, or an equivalent length with another unit).

### PRIOR ART

Numerous studies are carried out to develop new dispersing agents that would allow improving the rheological characteristics of compositions based on inorganic or organic fillers.

This is particularly true for the manufacture of concrete which necessitates having a fluid character conditioning its ease of implementation, or a reduction of its water content to improve the physical properties of the hardened concrete, as well as to allow for a prolonged conservation of the concrete initial fluidity.

Currently, concrete is the building material par excellence. The standard concrete includes four large categories of constituents; namely:
a inorganic filler that acts as an hydraulic binder,
sand, aggregates,
water
possible additives

Dispersing polymers referred to as plasticizers, superplasticizers, or water reducing agents are used to obtain the desired rheological properties.

Plasticizers and superplasticizers can be of various types. One can cite, for example, compounds such as condensates of the polynaphtalene sulfonate or melamine sulfonate type, as well as certain acrylic, methacrylic, maleic, allylic, vinylic polymers, or the like, including a main chain to which side chains are fixed that can be of different types and lengths.

These side chains can be hydrophilic such as polyethylene oxides, or hydrophobic such as alkyl chains. This last category of polymers is designated as the “comb” polymers.

They are described, for example, in the patent documents JP Sho 58-74552 and EP 0,056,627.

In their reference standard forms, the (co)polymers, for example, (meth)acrylic (co)polymers having a comb structure are generally sold as an aqueous solution with active ingredient content variable from 15 to 60%.

Solid forms are also available commercially. They are obtained, among other things, by methods that involve isolating the active ingredient of the aforementioned solution.

The main technique then used is that of “spray-drying”, which involves creating a cloud of fine droplets in a hot gaseous flow for a controlled period of time.

Other avenues for obtaining powdered superplasticizers are also possible. One will cite, for example, anhydrous or bulk polymerization and precipitation in a non solvent medium (such as acetone, methanol, and other polar solvents).

However, such methods are not industrially viable.

These comb-structured polymers have advantageous properties regarding the dispersion of fillers in a given medium. In particular, they allow stabilizing the dispersions due, among other things, to a steric repulsion of the particles between themselves.

However, in their current commercial form, whether liquid or powder, these polymers have a certain number of significant drawbacks such as those listed hereafter.

For the comb-like dispersants in liquid form:
relatively low concentration: high storage and water transportation cost
condition not adapted for dry mixtures.

For the comb-like dispersants in solid form commercially available and obtained by the previously-referenced techniques:
low density: hence a low efficiency of the packaging and high storage and transportation costs
difficult flowability, caking problems
presence of very fine particles with a pulverulent characteristic, which makes their manipulation difficult with a high risk of dust inflammation
polymer degraded during the congealing stage (polymer exposed to overly severe conditions, in particular, to exceedingly high temperatures)
a too slow solution annealing.

Therefore, there is a need that is for comb-structured dispersants that do not have these drawbacks, or to a lesser extent. To date, there is no solution despite the significance of the drawbacks and the research carried out to remedy them.

### DESCRIPTION OF THE INVENTION

Surprisingly, it has been found, according to the invention, that obtaining a comb-structured bead-form polymer made the polymer much more efficient than the commercially available forms, thus justifying its technical and commercial advantages.

The (co)polymers according to the invention are thus products such as described hereinabove, but characterized in that they are prepared in “beads” form.

The bead-forms are well known to one with ordinary skill in the art of (co)polymerization in the chemistry considered herein. One will simply be reminded that the bead-form polymers are generally obtained by the so-called suspension processes, well known to one with ordinary skill in the art and which do not need to be specified.

The (co)polymer of the invention is particularly characterized in that it has:
a specific gravity higher than 0.5, and preferably higher than 0.7; a specific gravity higher than that of superplasticizers currently commercially available in solid form,
a spherical “bead” shape and physical properties such as: greater flowability, better particle size distribution whereby a high fine particle content is averted, a low specific surface area whereby the moisture regain rate is lowered and caking is reduced,
   as a result of which a marked overall improvement in the use conditions is achieved when the (co) polymer is used as a plasticizer, a superplasticizer, or a dispersing agent, in comparison with the conditions observed during the use of the same materials marketed in different physical forms (e.g. as a fine powder obtained by spray-drying), particularly by virtue of the very fast availability (efficiency developed according to time) of the polymer in the medium.

This new physical form as a bead results in a marked overall improvement of the use conditions and/or performance when the polymer is used as a plasticizer, a superplasticizer, or a dispersant, in comparison with those observed for the same products marketed in other physical forms.

One could not envision that a method of suspension polymerization leading to a “beads” form would allow obtaining “comb” polymers with a greater efficiency than that of the commercially available products for use as a dispersant in compositions including organic and/or inorganic fillers.

The main advantages of the polymers of the invention are found in:

their method of manufacture:
low temperatures during the bead shaping step and, as a result, no degradation during this step
method enabling a higher productivity with respect to other existing “solid” methods

their physical characteristics:
improved flowability, easier apportionment, free-flowing product, prevention against clogging of the discharge, transport, or injection drains clogging due to improved flow.
few inflammation risks (few high fine particles)
Higher specific gravity: better optimization of the packaging

and surprisingly, with respect to their use:
slower moisture regain rate, which reduces storage constraints
higher dissolution speed.

The compositions of the invention are characterized in that they include organic and/or inorganic fillers, and at least one comb-structured bead-form polymer used as a dispersing and/or stabilizing agent.

The invention also relates to the use of comb-structured polymers as plasticizers, superplasticizers, water reducers, high-reduction water reducers in compositions including a hydraulic binder, such as concrete, mortar, slag, gypsum.

The numbers of possible field of application of comb-structured polymers is literally limitless. The dispersing effect of the comb-structured polymers is not limited to cement and concrete only. Due to their physical properties, the polymers of the invention are advantageous ingredients for any compositions that require dispersing organic and/or inorganic fillers, for example, but not exclusively, in compositions such as paints, coatings, and detergent, softening, or cosmetic compositions.

### EXAMPLES

1/ Preparation of the Polymers of the Invention

The method of preparing polymers in bead form by inverse suspension has been known since the late fifties.

This method requires 4 industrial steps (polymerization, distillation, liquid/solid separation, drying), instead of a single step necessary for obtaining a liquid polymer.

The bead-form “comb” polymers are obtained by dispersion of an aqueous phase in a hydrophobic phase. The water is then removed by distillation. Next, the dry polymer is filtered and dried.

The dispersion medium (hydrophobic phase) is constituted of a solvent that is insoluble in the aqueous phase and of a stabilizing agent. Most of the known stabilizing agents for the inverse suspensions (for example, those described in U.S. Pat. No. 2,982,749; U.S. Pat. No. 4,158,726; GB 1482515 and GB 1329062) can be used.

This hydrophobic phase is degassed for 30 minutes in nitrogen under agitation (200 rpm), a step that is necessary only in the case of suspension polymerization. The aqueous phase of monomer(s) or polymer(s) is then dispersed in the hydrophobic phase.

Conventionally, in the case of suspension polymerization, the polymerization initiator can be either of the azoic or similar type (i.e., resulting from thermal degradation), or of the oxidoreducing type or of the photo-initiator type. It can also be a combination of these two types of primers.

It is also possible to add to the aqueous phase of monomer(s) or polymer(s) other organic or inorganic compounds that are soluble or dispersible in the aqueous phase prior to the dispersion of this same aqueous phase in the hydrophobic phase. These compounds can include the following:
anti-foam agents, phosphoric esters, silicone polymers, alkoxylated alcohol, etc.
retarders or accelerators,
agents modifying the texture, the size of the bead,
fillers of any type: chalk, bentonite, titanium dioxide, flue dust, aluminium silicate, talc, lime, gypsum, china clay, barium sulphate, etc.

The resulting beads are separated from the hydrophobic phase by filtration on a sieve, with or without a preliminary dehydration step. The beads are then cleaned from their residues from the hydrophobic phase in a final drying step.

The resulting beads are spherical with a diameter between 50 μm and 1000 μm, with a distribution conventionally centered between 100 and 500 μm.

The one with ordinary skill in the art will know how to select the best combination based on his own knowledge and the present description.

2/ Comparative Tests

2a/Flowability Test

The PBa and PBb polymers were prepared according to the previously described technique and referred to as inverse suspension.
PBa: comb polymer according to the invention (methacrylate of methoxy polyethylene glycol/acrylic acid) obtained in bead form with the inverse suspension method previously described.
PBb: comb polymer according to the invention (polyethylene glycol mono allyl ether/maleic acid) obtained in bead form with the inverse suspension method previously described.

The P1, P2, and P3 polymers are used as comparative examples.
P1: comb polymer (methacrylate of methoxy polyethylene glycol/acrylic acid) obtained in aqueous solution form such as described in the example 1 of Patent Sho 58-74552.
P2: comb polymer (polyethylene glycol mono allyl ether/maleic acid) obtained in aqueous solution form such as described in the example 1 of Patent EP 0,056,627.
The polymers 1, 2 are in solutions with concentrations of 40 and 48%, respectively. The pH is adjusted to 6.
P1SD: P1 polymer is obtained in powder form by the “spray-drying” technique.
P2SD: P2 polymer is obtained in powder form by the “spray-drying” technique.

The chemistry and chemical structure of the PBa and PBb polymers correspond respectively to those of the P1 and P2 polymers, respectively.

Description of the Flowability Measurement:

This measurement is determined by measuring the flowability time of 50 g of powder in a stainless steel funnel with the following dimensions: height 15 cm, upper diameter 11.5 cm, lower diameter 1 cm.

| Polymer | Aspect | Flowability | Miscellaneous |
|---|---|---|---|
| P1SD | beige-colored | does not flow | sticky powder |
| ad: 0.45 | powder | freely | |
| P2SD | beige-colored | does not flow | sticky powder |
| ad: 0.43 | powder | freely | |
| PBa | beige-colored | 6 seconds | average particles size of |
| (invention) | beads | | 100 microns |
| ad: 0.72 | | | |
| PBb | beige-colored | 7 seconds | average particles size of |
| (invention) | beads | | 200 microns |
| ad: 0.70 | | | |

(ad = apparent density, obtained by measuring the polymer's mass contained in a 100 ml test specimen after settling with 10 identical shaking movements).

One notes that only the polymers of the invention (i.e., PBa and PBb), obtained as beads, flow freely.

2b/ Efficiency Test

This test aims at comparing the dispersing qualities of the comb polymers with respect to their physical form (dried spray powder, beads, and liquid).

In order to give these tests a probative value, they were carried out on a representative composition (high proportion of inorganic fillers) and according to an EN 480-1 standard-compliant process, ISO mortar formulation, on which the mixing time necessary for obtaining an optimal efficiency was used as a variable.

a- Raw materials

| | |
|---|---|
| Ø standardized sand NF EN 196-1 | Ø CPA 52.5 PM (Vicat) cement |

b- Composition of the mortar

| | | | |
|---|---|---|---|
| CEMENT (C) | 450 g | 25 | T° C. water = 21° C. |
| SAND (S) | 1350 g | | T° C. lab = 20° C. |
| WATER (W) | 250 g | | T° C. mortar = 20° C. |
| Superplasticizer | 0.22% in dry/cement | | |
| i.e. 1 g | | | |

Description of the Spreading Measurement:

Spreading is measured on a stainless steel plate (30×30 cm). The value is obtained after a cone (12×8 cm) is filled with the mortar, which is then placed on the plate and removed. Then, the average value of the diameter of the cake formed is measured in 3 locations with a ruler: the higher the spreading, the more efficient the polymer.

| | | Spreading | |
|---|---|---|---|
| | | with a mixing | |
| | Spreading | time divided | Spreading with |
| | with a mixing | by 2 with | a mixing time |
| | time according | respect to | divided by 4 with |
| | to the EN 480-1 | the EN 480-1 | respect to the EN |
| | standard (in | standard (in | 480-1 standard |
| Superplasticizer | mm) | mm) | (in mm) |
| White without | 120 | 120 | 120 |
| polymer | | | |
| P1 (liquid) | 305 | 305 | 305 |
| P2 (liquid) | 250 | 250 | 250 |
| P1SD (spray | 275 | 270 | 260 |
| dried) | | | |
| P2SD (spray | 230 | 210 | 200 |
| dried) | | | |
| PBa (invention) | 305 | 305 | 305 |
| PBb (invention) | 250 | 250 | 250 |

The above results show in an unexpected and surprising fashion, contrary to the other commercially available solid form obtained with the spray drying technique, that:
the polymers of the invention retain an efficiency that remains unchanged with respect to the polymer in liquid form
even with a very short mixing time with respect to the norm (that is as recommended by the EN 480-1 standard), the bead-form polymers of the invention have a maximum efficiency.

1. A composition comprising a) at least one comb-structure dispersing (co)polymer in the form of beads, and b) at least one of an organic filler and an inorganic filler.

2. The composition according to claim 1, wherein the comb-structure polymer comprises a main chain to which side chains having hydrophilic and/or hydrophobic units of ethylene oxide and/or propylene oxide and/or alkyl types with lengths of 2 to 500 units are attached.

3. The composition according to claim 1, wherein the comb-structure polymer comprises a main chain to which side chains having units of hydrophilic and/or hydrophobic types with lengths of 2 to 200 units are attached.

4. The composition according to claim 1, wherein the comb-structure polymer is partially based on methacrylate of methoxy polyethylene glycol and/or polyethylene glycol mono allyl ether.

5. The composition according to claim 1 wherein the comb-structure polymer is a copolymer based on methacrylate of methoxy polyethylene glycol and/or polyethylene glycol mono allyl ether and acrylic acid and/or methacrylic acid and/or maleic acid and/or their salts.

6. The composition according to claim 1, wherein the comb-structure polymer is in the form of beads having an apparent specific gravity higher than 0.5.

7. (canceled)

8. (canceled)

9. The method of claim 12, wherein the comb-structure polymer comprises a main chain to which side chains that include hydrophilic and/or hydrophobic units of ethylene oxide and/or propylene oxide and/or alkyl types with lengths of 2 to 500 units are attached.

10. Concrete, mortar, slag, slurry, or gypsum comprising at least one composition according to claim 1.

11. The composition according to claim 6 wherein the beads have an apparent specific gravity higher than 0.7.

12. A method of preparing a composition comprising combining a) at least one comb-structured bead-form polymer and b) a hydraulic binder.

13. The method of claim 12 wherein the bead-form polymer is at least one of a plasticizer, superplasticizer, water reducer, and high-reduction water reducer agent.

14. The method of claim 12 wherein the hydraulic binder comprises at least one of concrete, mortar, slag, slurry, gypsum.

15. A paint, coating composition, detergent, softening composition or cosmetic composition comprising at last one composition according to claim 1.

16. A method of preparing a composition comprising at least one of paint, coating composition, detergent, softening composition and cosmetic composition, the method comprising combining a) at least one comb-structured bead-form polymer, and b) at least one of an organic filler and an inorganic filler.

17. The method of claim 16 wherein the at least one comb-structured bead-form polymer is a dispersing agent.
